(19) United States
(12) Patent Application Publication
(10) Pub. No.: US 2011/0257569 A1
(43) Pub. Date: Oct. 20, 2011

(54) MASSAGE DEVICE

(76) Inventor: Susan Z. Robins, Brookline, MA (US)

(21) Appl. No.: 12/761,371

(22) Filed: Apr. 15, 2010

(51) Int. Cl. A61H 7/00

(52) U.S. Cl. 601/137

(57) ABSTRACT

This invention provides a massage device having a unibody construction. The massage device has an ovoid shaped handle, a spherical center portion with a multitude of nubs, and a sculpted tip. In another embodiment, the massage device has a multipiece construction of a rod and a massaging component. The massaging component may be spherical, wheel shaped, and/or barrel shaped. The massaging component has an outer surface with a multitude of nubs. The interior of the massaging component is hollow such that it frictionally engages with the rod. The rod has a sculpted tip. Multiple massaging components may be positioned on the rod in a variety of configurations depending upon the body part to be massaged. In either embodiment, an optional sleeve may be used in conjunction with the massage device. The sleeve may be may be made of plastic mesh or fabric.

### CROSS-REFERENCE TO RELATED APPLICATION(S)

The present application may include subject matter related to one or more of the following commonly-owned United States patent applications, each of which was filed on even date herewith and is hereby incorporated herein by reference in its entirety: U.S. Design Application No. 29/342160 filed Aug. 19, 2009.

### TECHNICAL FIELD

This invention relates to a massage device. More specifically, the invention relates to an ergonomic massage device for individuals that suffer from chronic muscle tension and pain.

### BACKGROUND

8 out of 10 people in the U.S. suffer from chronic muscle pain and/or tension headaches. Many of these people experience continued muscle soreness and spasms, bilateral hand and arm pain, upper and lower back pain, piriformis syndrome/sciatica, tight iliotibial (IT) bands, tension headaches, facial pain caused by temporomandibular joint and muscle disorders (TMJDs), plantar fasciitis, referred pain associated with arthritis and fibromyalgia, leg cramps, tendonitis and carpal tunnel injuries, general stress, and more.

Today's competitive landscape for self-massage tools is quite large. At the low end, the market includes small massage balls. At the high end, there are electric massage devices and massage chairs. There are products that are designed for trigger point massage. These products tend to have hard tips that can dig deep into the belly of a muscle, but are not useful for deep tissue and/or Swedish massage. There are also massage balls, which tend to be round, hard or soft, large or small, with spiky nubs (of varying shapes, sizes, and densities). These products are not useful for acupressure or trigger point massage and are often too hard, too soft, too large, or too small to be effective for sensitive muscles.

Typically, the existing products are sold online through Internet commerce sites, and in some cases, through brick and mortar retail outlets.

Additionally, it is worth noting that people in pain will often rely on non-massage related products to help reduce muscle pain. The most common “creative” tools include tennis balls, squash balls, the end of a large wooden spoon (for deep tissue trigger point work), and foam rollers are often used for stretching tight muscles.

Thus, there does not appear to be one “single” solution that meets every person's pain needs. Furthermore, there are no solutions for people who suffer from bi-lateral hand and arm problems. In addition, none of the devices described above offer a “hands-free” option.

### SUMMARY

It is a goal of the present invention to provide a massage device that may be used on a variety of body parts.

It is another goal of the present invention to provide a massage device that may be used with a variety of massage techniques.

It is a yet another goal of the present invention to provide a massage device that may be used in a hands free manner and without the need for assistance from a partner.

It is a further goal of the present invention to provide a massage device that is ergonomic, lightweight, portable, and easy to use.

This invention overcomes the disadvantages of the prior art by providing a massage device having a unibody construction. The massage device has an ovoid shaped handle, a spherical center portion with a multitude of nubs, and a sculpted tip positioned within the spherical center portion and the handle. Each of these features has been ergonomically designed in their size, shape, and density so that they provide maximum comfort and relief.

In another embodiment, the massage device has a multipiece construction of a rod and a massaging component. The massaging component may be spherical, wheel shaped, and/or barrel or oval shaped. The massaging component has an outer surface with a multitude of nubs. The interior of the massaging component is hollow such that it frictionally engages with the rod. Alternatively, fasteners may be used to hold the massaging components in place on the rod. The rod has a sculpted tip. Multiple massaging components may be positioned on the rod in a variety of configurations depending upon the body part to be massaged.

In either embodiment, an optional sleeve may be used in conjunction with the massage device. The sleeve may be made of plastic mesh or fabric.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

The invention description below refers to the accompanying drawings, of which:

FIG. 1 is a top view of one embodiment of the massage device of the present invention;

FIG. 2 is a front view thereof;

FIG. 3 is a rear view thereof;

FIG. 4 is a bottom view thereof;

FIG. 5 is a perspective view thereof;

FIG. 6 is an exploded view thereof;

FIG. 7 is a front view of an alternative embodiment of the massage device of the present invention;

FIG. 8 is a left side view thereof;

FIG. 9 is a right side view thereof;

FIG. 10 is a perspective view thereof;

FIG. 11 is an exploded view thereof; and

FIG. 12 is a series of perspective views of various massage components and rods that may be combined to form alternative embodiments of the present invention.

### DETAILED DESCRIPTION

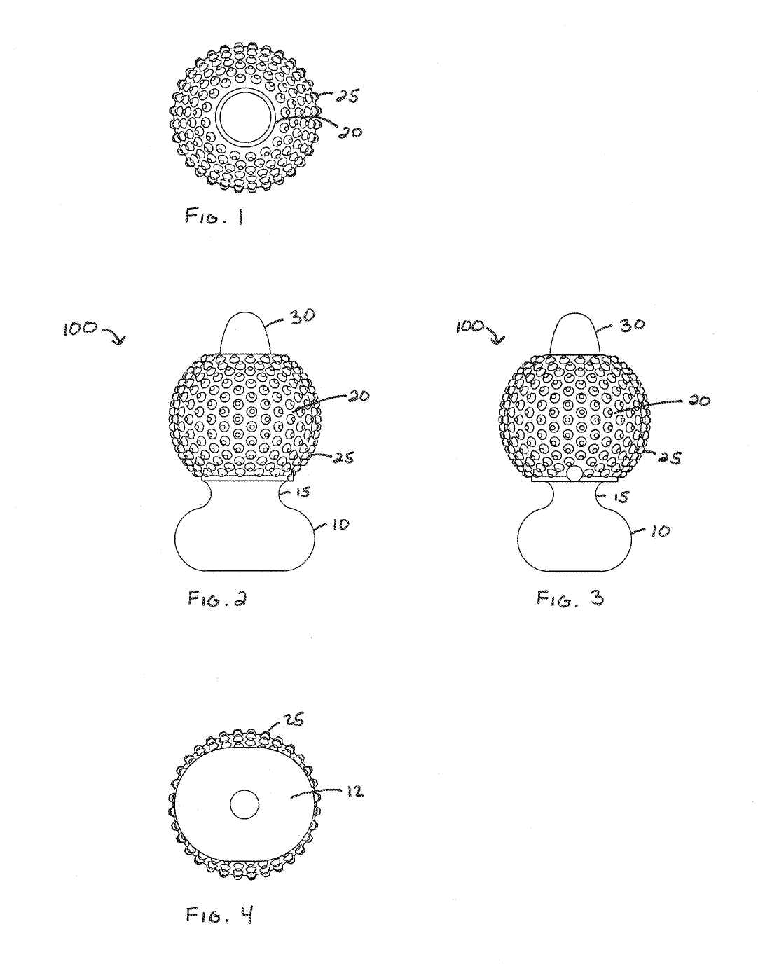

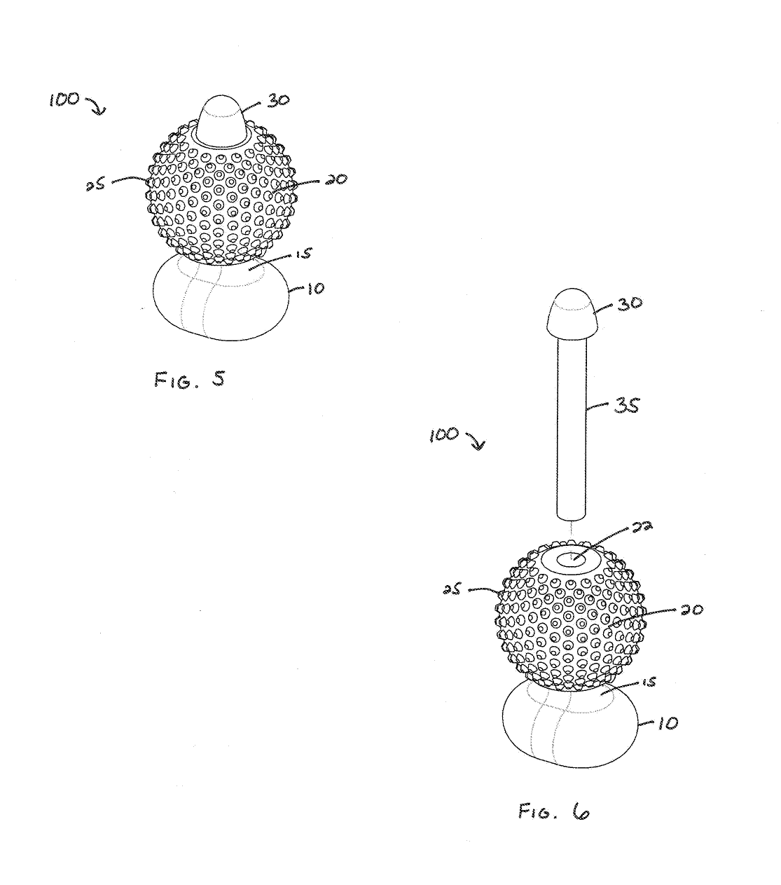

Referring generally to FIGS. 1-6, there is provided a massage device 100. Massage device 100 has a handle 10, a center ball portion 20, and a tip 30. Handle 10 has a neck 15 that connects handle 10 to center ball portion 20. Center ball portion 20 has a multitude of nubs 25. Tip 30 is the upper portion of a rod 35 that extends through center ball portion 20 into handle 10 via neck 15. In one embodiment, the height of massage device 100 from handle 10 to tip 30 is about 5.1 inches.

Handle 10, neck 15, and center ball portion 20 are made of flexible polyvinyl chloride (PVC). In one embodiment, a PVC polymer of approximately 40 durometers is used to construct handle 10, neck 15, and center portion 20. Tip 30 and rod 35 are made of a rigid PVC. Alternatively, handle 10, neck 15, and center ball portion 20 may be made of urethane and tip 30 and rod 35 may be made of polypropylene.

Handle 10 may be ovoid in shape. Handle 10 and neck 15 each have a hollow interior portion to allow for insertion of rod 15. Handle 10 is ergonomically shaped to fit comfortably in the hand of the user, regardless of the size of the user's hand, and allowing the user to control the desired amount of pressure. The surface of handle 10 is textured to provide sufficient frictional contact with the user's hand such that there is no slippage when applying pressure or torque to handle 10. Handle 10 has a flat bottom surface 12. Handle 10 has a wide side and a narrow side and the user may grasp handle 10 on either side. In one embodiment, handle 10 has a diameter of 2.75 inches on the wide side and a width of 2.25 inches on the narrow side. Alternatively, the user may lean against handle 10 to apply pressure for use in trigger point massage techniques.

Center ball portion 20 may be spherical in shape. Center ball portion 20 has a hollow interior portion 22 to allow for insertion of rod 35. In one embodiment, the diameter of center ball portion 20 is about 2.8 inches, the height of center ball portion 20 is about 2.4 inches, and the hollow interior portion has a diameter of about 0.6 inches. Center ball portion 20 is used to apply pressure to a body part of the user. Alternatively, the user may use center ball portion 20 as a hand grip. In one embodiment, center ball portion 20 has approximately 290 nubs. Nubs 25 may be frusto-conical in shape. In one embodiment, nubs 25 have a height of about 0.09 inches and diameter of about 0.2 inches at the base of the nub and about 0.09 inches at the top of the nub. Nubs 25 work in unison to massage the fascia of the user's muscles in deep tissue and/or myofascial release massage techniques.

Tip 30 may be a rounded cone shape. In one embodiment, tip 30 is about 1.8 inches in height. Tip 30 is designed to stimulate circulation and penetrate into muscles to release knots and tightness. Rod 35 is cylindrical in shape and is inserted into tip 30. Rod 35 has two ends, a tapered top end that inserts into tip 30 and a bottom end. In one embodiment, rod 35 is about 3.5 inches long, the tapered top end has a length of about 0.25 inches and has a diameter of about 0.5 inches, while the bottom end has a diameter of about 0.6 inches. The combination of rod 35 and tip 30 are inserted into the hollow interior portion of center ball portion 20, neck 15 and handle 10 and held in place by an adhesive.

In use, the combination of handle 10, center ball portion 20, and tip 30 are well suited to applying rotational, stroking, tapping, and pressing motions when performing various massage techniques. Massage device 100 may also be used in a hands free manner in which the device is placed against a wall, door frame, floor, or piece of furniture. The body weight of the user is used to adjust the amount of pressure on the body part being massaged. In an alternative embodiment, massage device 100 may be used in conjunction with a sleeve (not shown) for hard to reach places. In one embodiment, the sleeve is made of plastic mesh, but may be made of other materials. The sleeve has two open ends. The massage device is placed in one open end of the sleeve. The other open end of the sleeve is tied off by a knot or rubber band. The user may then position the massage device in the desired location.

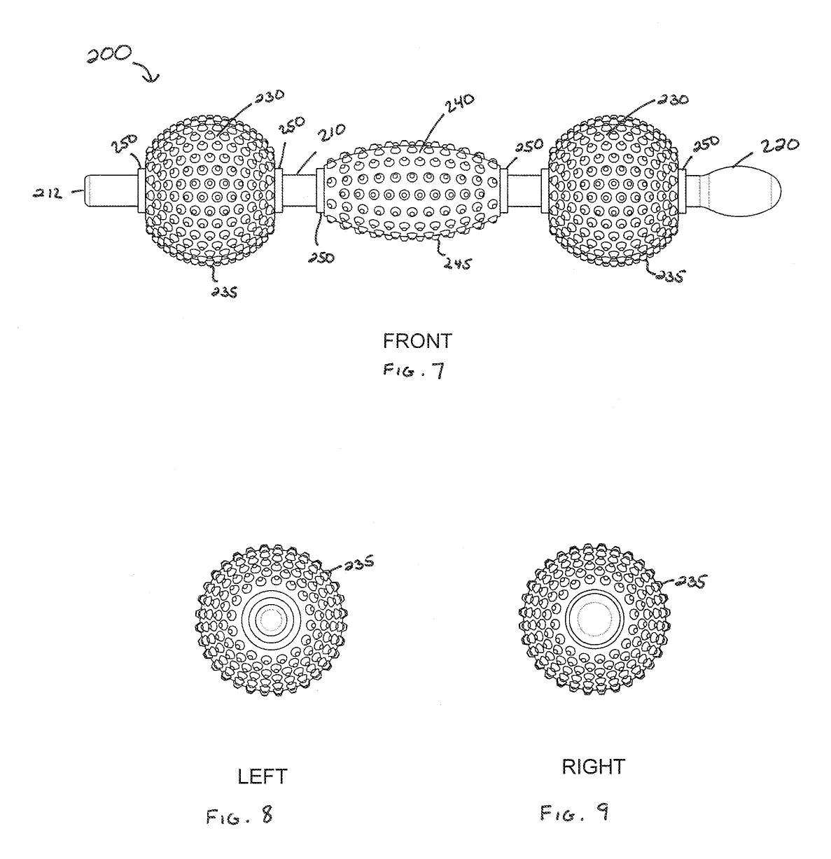

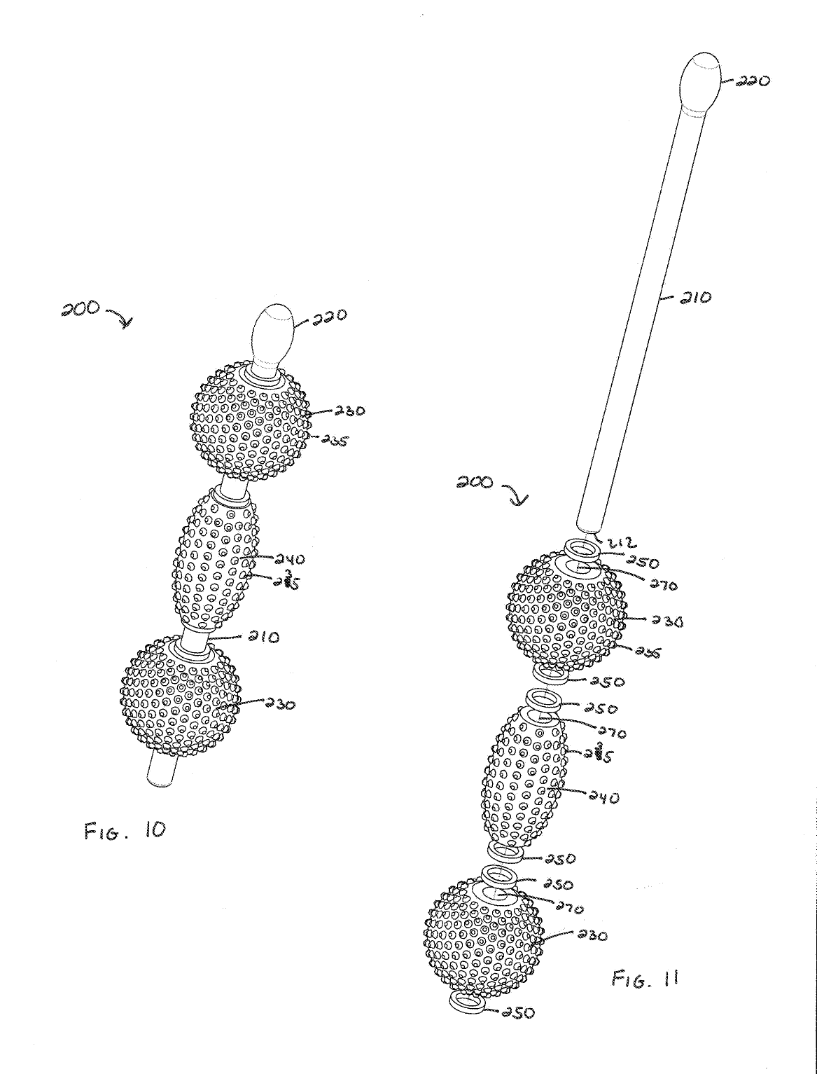

Referring generally to FIGS. 7-12, an alternative embodiment of the massage device 200 is provided. Massage device 200 has a rod 210 with a tip 220 and a number of massaging components 230 and 240. Rod 210 is cylindrical in shape and has two ends, a top end with tip 220 and a bottom end 212. The bottom end 212 of rod 210 is inserted into the hollow interior portion 270 of massaging components 230, 240. Tip 220 is designed to stimulate circulation and penetrate into muscles to release knots and tightness.

Each massaging component 230, 240 has an outer surface with a multitude of nubs 235. Nubs 235 may be frusto-conical in shape. In one embodiment, nubs 235 have a height of about 0.09 inches and diameter of about 0.2 inches at the base of the nub and about 0.09 inches at the top of the nub. Nubs 235 work in unison to massage the fascia of the user's muscles in deep tissue and/or myofascial release massage techniques.

The interior 270 of each massaging component 230, 240 are hollow such that it frictionally engages with rod 210. A fastener, such as a washer or O-ring 250 are used to secure massaging components 230, 240 in place once they are in the desired location on rod 210.

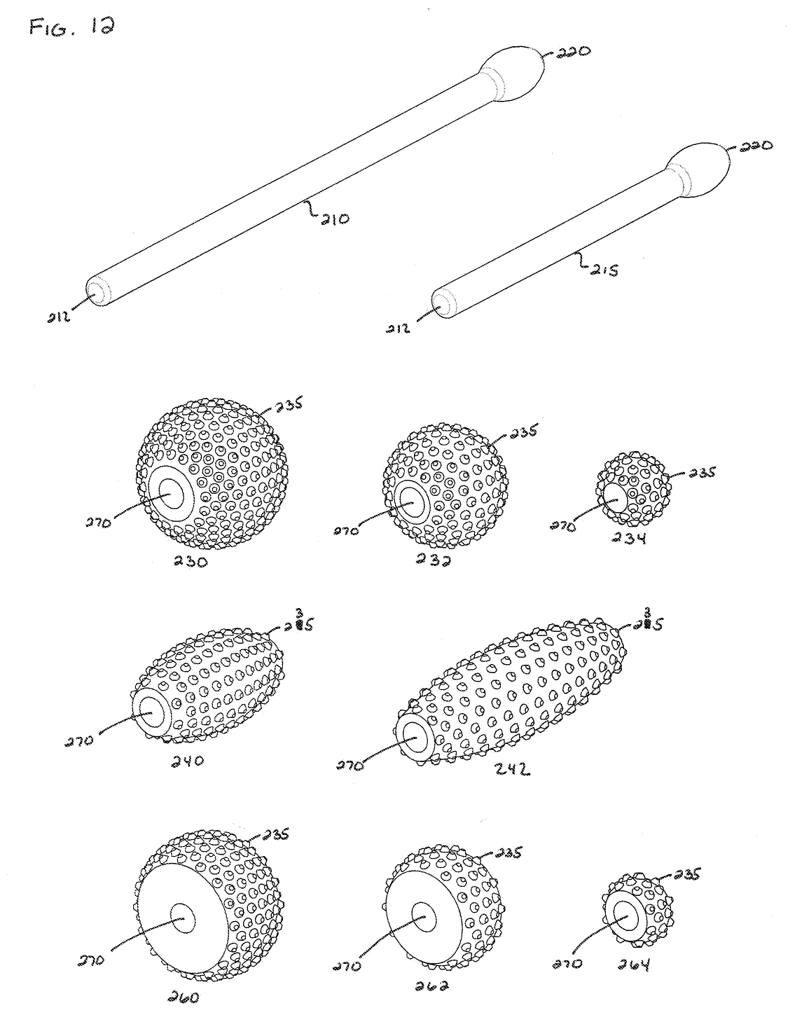

As shown in FIG. 12, there are multiple massaging components that may be positioned on the rod in a variety of configurations depending upon the body part to be massaged. The massaging components may be spherical 230, 232, 234, barrel/oval shaped 240, 242, and/or wheel shaped 260, 262, 264. The massaging components are made of a flexible polyvinyl chloride (PVC). In one embodiment, a PVC polymer of approximately 35 to 70 durometers is used to construct the massaging components. The rod may vary in length 210, 212. Rod 210 and 220 are made of a rigid PVC.

In one embodiment, the spherical massaging components may range in size from small 234 to medium 232 to large 230. The hollow interior portion 270 of each spherical massaging component 230, 232, 234 has a diameter of about 0.6 inches. The small spherical massaging component 234 has a diameter of about 1.5 inches and a width of about 1.2 inches. The medium spherical massaging component 232 has a diameter of about 2.5 inches and a width of about 2.1 inches. The large spherical massaging component 230 has a diameter of about 3.0 inches and a width of about 2.6 inches.

In one embodiment, barrel/oval shaped massaging components may be small 240 or large 242 in size. The hollow interior portion 270 of each barrel/oval massaging component has a diameter of about 0.6 inches. The small barrel/oval massaging component 240 has a diameter of about 3.5 inches and a width at the middle of about 2.0 inches. The large barrel/oval massaging component 242 has a diameter of about 6.0 inches and a width at the middle of about 2.0 inches.

In one embodiment, the wheel massaging components may range in size from small 264 to medium 262 to large 260. The hollow interior portion 270 of each wheel massaging component has a diameter of about 0.6 inches. The small wheel massaging component 264 has a diameter of about 1.5 inches and a width of about 0.8 inches. The medium spherical massaging component 262 has a diameter of about 2.5 inches and a width of about 1.25 inches. The large spherical massaging component 260 has a diameter of about 3.0 inches and a width of about 1.6 inches.

In one embodiment, the rod may be small 215 or large 210 in size. Each rod 210, 215 has a diameter of about 0.6 inches. The large rod 210 has a length of about 12 inches. The length of the large rod 210 from the bottom end to the tip 220 is about 14.0 inches. The small rod 215 has a length of about 7.0 inches. The length of the small rod 215 from the bottom end to the tip 220 is about 9.0 inches. The diameter of tip 220 at its widest point is about 1.0 inch.

In use, the combination of tip 220 and massaging components 230, 240 are well suited to applying rotational, stroking, tapping, and pressing motions when performing various massage techniques. Massage device 200 may also be used in a hands free manner in which the device is placed against a wall, door frame, floor, or piece of furniture. The body weight of the user to adjust the amount of pressure on the body part being massaged.

The foregoing has been a detailed description of illustrative embodiments of the invention. Various modifications and additions can be made without departing from the spirit and scope if this invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Accordingly, this description is meant to be taken only by way of example, and not to otherwise limit the scope of this invention.

1. A massage device comprising:
a handle, the handle having a neck;
a central ball portion, the central ball portion being connected to the handle by the neck, wherein the central ball portion has a plurality of nubs disposed thereon, and wherein the handle, the neck, and the central ball portion each have an interior hollow portion; and
a rod; the rod having a tip positioned thereon, wherein the rod is inserted through the hollow interior portions of the central ball portion, the neck, and the handle, such that the tip of the rod is disposed upon the central ball portion.

2. The massage device of claim 1 wherein the handle, the neck, and the central ball portion have a unibody construction.

3. The massage device of claim 1 wherein the handle, the neck, and the central ball portion are made of flexible polyvinyl chloride.

4. The massage device of claim 1 wherein the rod and the tip are made of rigid polyvinyl chloride.

5. The massage device of claim 1 wherein the handle is ovoid in shape.

6. The massage device of claim 1 wherein the handle is adapted for gripping.

7. The massage device of claim 1 wherein the handle is textured to provide sufficient frictional contact with a user's hand such that there is no slippage when applying pressure or torque to the handle.

8. The massage device of claim 1 wherein the handle has a flat bottom surface, a wide side and a narrow side, and wherein the user may grasp the handle on the wide side or the narrow side.

9. The massage device of claim 1 wherein the central ball portion is spherical in shape.

10. The massage device of claim 1 wherein the plurality of nubs are frusto-conical in shape.

11. The massage device of claim 1 wherein the central ball portion has approximately 290 nubs.

12. The massage device of claim 1 wherein the tip is a rounded cone shape.

13. The massage device of claim 1 wherein the rod is cylindrical in shape.

14. The massage device of claim 1 wherein the rod has a tapered top end and a bottom end, the tapered top end being inserted into the tip.

15. The massage device of claim 1 wherein the rod is held in place within the hollow interior portions of the central ball portion, the neck, and the handle by an adhesive.

16. The massage device of claim 1 wherein the handle, the central ball portion, and the tip are adapted for applying therapeutic pressure to a muscle.

17. The massage device of claim 1 further comprising a sleeve.

18. The massage device of claim 17 wherein the sleeve is made of plastic mesh or fabric.

19. A massage device comprising:
a plurality of massaging components being positioned upon a rod, wherein the plurality of massaging components have a plurality of nubs disposed thereon, wherein the plurality of massaging components engage the rod via a frictional fit, and wherein the rod has a tip.

20. The massage device of claim 19 wherein the plurality of massaging components is selected from the group consisting of wheel-shaped, barrel-shaped, spherical-shaped, and a combination thereof.

21. The massage device of claim 19 wherein the plurality of massaging components are held in position on the rod by a plurality of fasteners.
